(19) United States
(12) Patent Application Publication
(10) Pub. No.: US 2024/0062391 A1
(43) Pub. Date: Feb. 22, 2024

(54) METHODS, SYSTEMS, ARTICLES OF MANUFACTURE AND APPARATUS FOR STATIC AND DYNAMIC SEPARATION MASK ESTIMATION

(71) Applicant: Intel Corporation, Santa Clara, CA (US)

(72) Inventors: Niloufar Pourian, Los Gatos, CA (US); Alexey Supikov, Santa Clara, CA (US)

(21) Appl. No.: 18/498,952

(22) Filed: Oct. 31, 2023

(51) Int. Cl. G06T 7/246; G06T 5/00

(52) U.S. Cl. CPC G06T 7/246; G06T 5/002; G06T 2207/10016; G06T 2207/20084; G06T 2207/20081

(57) ABSTRACT

Systems, apparatus, articles of manufacture, and methods are disclosed to improve separation mask estimation. An example apparatus includes interface circuitry, instructions, and programmable circuitry to at least one of instantiate or execute the instructions to deactivate a motion network and activate an attribute network in response to a frame input of a stream to a neural network. The example apparatus also executes the instructions to train the attribute network based on the frame input, activate the motion network and deactivate the attribute network in response to a subsequent frame input of the stream to the neural network, train the motion network based on the subsequent frame, and determine pixels of the video stream that are moving.

### FIELD OF THE DISCLOSURE

This disclosure relates generally to image and/or video processing and, more particularly, to methods, systems, articles of manufacture and apparatus for static and dynamic separation mask estimation.

### BACKGROUND

In recent years, video analysis applications have become available on computing devices. Such video analysis applications permit user-specified scene views to be generated based on acquired video frames that do not necessarily have the same point of view.

### BRIEF DESCRIPTION OF THE DRAWINGS

FIG. 1 is a block diagram of an example environment in which example network management circuitry operates to improve separation mask estimation in a manner consistent with teachings of this application.

FIG. 2 is a block diagram of an example separation mask network for static and dynamic separation mask estimation.

FIG. 3 is a block diagram of an example implementation of the network management circuitry of FIG. 1.

FIG. 4 is a block diagram of an example network activation schedule for static and dynamic separation mask estimation.

FIG. 5 is a flowchart representative of example machine readable instructions and/or example operations that may be executed, instantiated, and/or performed by example programmable circuitry to implement the network management circuitry of FIGS. 1 and/or 3.

FIG. 6 is a block diagram of an example processing platform including programmable circuitry structured to execute, instantiate, and/or perform the example machine readable instructions and/or perform the example operations of FIG. 5 to implement the network management circuitry of FIGS. 1 and/or 3.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIG. 5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Artificial intelligence (AI), including machine learning (ML), deep learning (DL), and/or other artificial machine-driven logic, enables machines (e.g., computers, logic circuits, etc.) to use one or more models to process input data to generate an output based on patterns and/or associations previously learned by the model(s) via one or more training processes. For instance, the model(s) may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a neural radiance field (NeRF) model is used. Using a NeRF model enables generation of three-dimensional (3D) representations of an object or scene from two-dimensional (2D) images. From such 3D representation, the NeRF training algorithms (e.g., models) generate synthesized views of a scene that are based on other captured scene frames, and permit user-specified scene views to be generated based on acquired video frames that do not necessarily have the same point of view. This and many other video analysis applications benefit from being able to tell if particular pixels correspond to moving (e.g., dynamic) or non-moving (e.g., static) content. Such applications typically rely on being able to infer a per-pixel map indicating if a pixel represents (or is associated with) a static or moving object. Such a map is referred to herein as a static and dynamic content separation mask, sometimes referred to herein as a separation mask. Using only the captured scene frames and associated camera parameters, NeRF training algorithms reconstruct spatial color (e.g., radiance) and density distribution information corresponding to the scene. Radiance and density distribution information is represented using neural networks or elements of neural networks. Using radiance and density distribution information, NeRF rendering algorithms can generate alternate synthesized views. Although NeRF machine learning models/architectures are used in some examples disclosed herein, other types of machine learning models could additionally or alternatively be used.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are training parameters that are typically determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In some examples disclosed herein, ML/AI models are built and/or otherwise constructed from any number of neural networks having any number of layers trained using, for example, rendering loss analysis, gradient descent, etc. However, any other training algorithm may additionally or alternatively be used. In some examples disclosed herein, training is performed until convergence and/or diminishing results of a gain/loss function. In some examples disclosed herein, training is performed at the same device that ultimately renders images and/or video streams. Training is performed on computing platforms having a requisite amount of processing capability (e.g., cloud service providers, Edge accelerators, etc.). As such, training is performed on devices that do not ultimately render the images and/or video streams to end users, in some examples. In some examples, training is performed using hyperparameters that control how the learning is performed (e.g., a learning rate, a number of layers to be used in the machine learning model, etc.).

Training is performed using training data. In some examples disclosed herein, the training data originates from captured frames and their corresponding spatial and color data. Because supervised training is used in some examples, the training data is labeled in such examples. Once training is complete, the model (e.g., one or more neural networks) may be deployed for use as an executable construct that processes an input and provides an output based on the network of nodes and connections defined in the model. In some examples, the model(s) (neural networks) is/are stored at a rendering device. In some examples the model(s) is/are stored off the rendering devices (e.g., on other devices and/or in network storage locations). The model may then be executed by the rendering devices and/or by another device such as one or more network nodes, one or more cloud service providers, one or more Edge devices, one or more accelerators, etc.

Once trained, the deployed model(s) may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model(s) may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

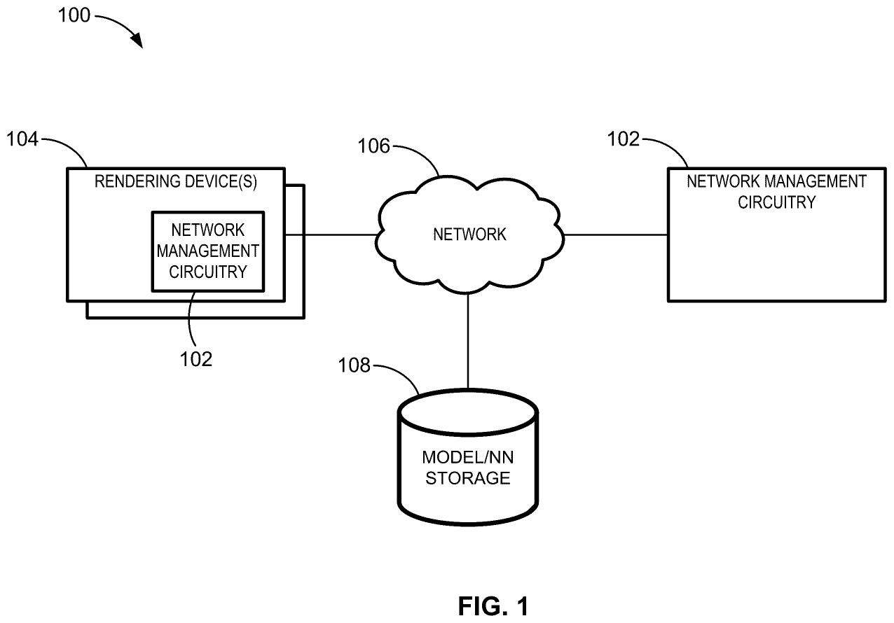

FIG. 1 is a block diagram of an example environment 100 in which example network management circuitry 102 operates for static and dynamic separation mask estimation. In the illustrated example of FIG. 1, the environment 100 includes one or more rendering devices 104, such as one or more personal computers, one or more smart televisions, one or more wireless telephones and/or any other type of device(s) that can render audio and/or video. The example rendering device(s) 104 are communicatively connected to one or more networks 106, such as the Internet, intranets, public/private networks, wireless telephone networks, etc. The example networks 106 are also communicatively connected to the example network management circuitry 102 and model storage 108. In some examples, the model storage 108 stores any number of models, neural networks and/or combinations of two or more neural networks. In the illustrated example of FIG. 1, example network management circuitry 102 is shown within rendering devices 104 and as separate (e.g., stand-alone) structure (see right-hand side of FIG. 1). In the event the example network management circuitry 102 is not part of and/or otherwise included in the example rendering devices 104, the network management circuitry 102 is part of a separate platform of computational resources, such as within a cloud service provider (CSP), a server or rack of servers, an Edge node, an accelerator (e.g., a graphical processing unit (GPU)), etc.

In operation, and as described in further detail below, the example network management circuitry 102 receives video stream data in the form of frames that, in some examples, arrive in a temporal manner. As used herein, a frame is a data structure of video data at a point in time. The frame includes pixel data and camera parameters. The pixel data includes color information. The camera parameters include information corresponding to camera position, field-of-view and, in some examples, optical distortion. Examples disclosed herein facilitate the creation of free-viewpoint images and/or video, in which environment scenes may be generated at arbitrary spatial locations even when frames associated with those arbitrary spatial locations have not been acquired. Stated differently, free-viewpoint images permit a viewer/user to select a viewing position and angle of interest for a scene. Neural radiance field (NeRF) model approaches generate free-viewpoint images based on a series of previously captured frames. In particular, known NeRF approaches implement buffer structures to store a substantial number of frames (e.g., at least 30 frames) to facilitate static and dynamic separation mask generation that distinguishes particular pixels that are moving from other pixels that are stationary from one frame to the next in a temporal series of frames. Stated differently, known approaches utilize such buffer storage devices to facilitate bulk training efforts, in which capturing sufficient input frames consumes time, storage resources and computational resources. However, because a relatively large quantity of previously-acquired frames (e.g., a bulk quantity of frames) is needed, known NeRF approaches for generating free-viewpoint images are not well suited for streaming scenarios. Known NeRF approaches implement optical flow mapping techniques to assist with separation mask generation, which is bandwidth intensive and computationally intensive.

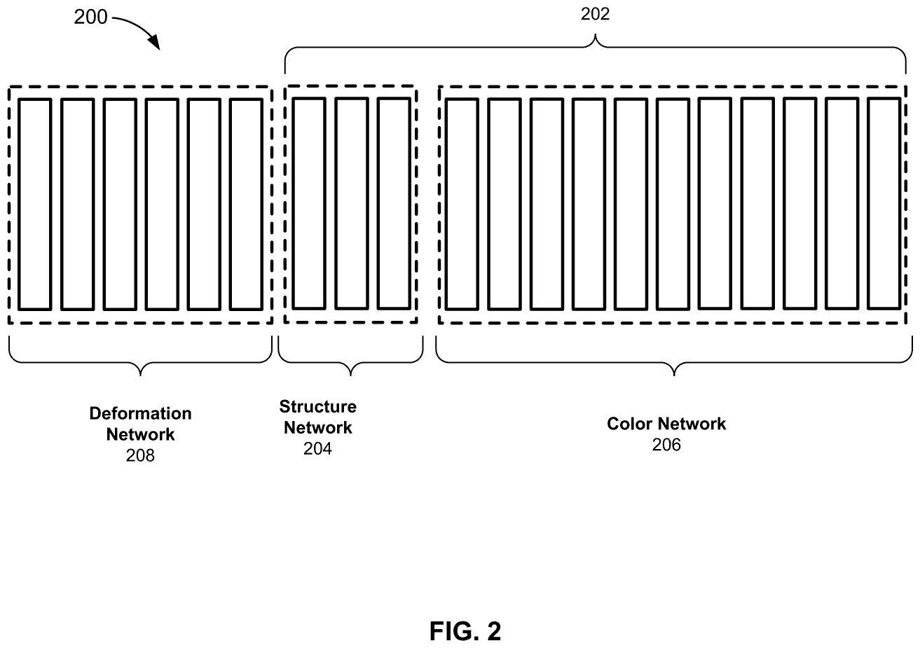

FIG. 2 illustrates an example separation mask network 200 for separation mask estimation. In the illustrated example of FIG. 2, the separation mask network 200 includes an incremental neural video (INV) network 202 that includes an example structure network 204 and an example color network 206. In some examples, the INV network 202 is referred to as an attribute network 202 or an attribute sub-network 202. NeRF models are based on multi-layer perceptrons (MLPs), which is a type of feed forward neural network having an input layer, an output layer and hidden layers. Neurons in an MLP are trained with, for example, back propagation learning algorithms.

When a same NeRF MLP is trained progressively on a time sequence of video frames (e.g., when the same neural network is trained for 10,000 iterations on a first time frame of video, then trained for 10,000 iterations on a subsequent time frame of video, and so on), it exhibits a partitioning behavior (e.g., a spontaneous partitioning behavior) that separates the NeRF model into structure layers (e.g., the example structure network 204) and color layers (e.g., the example color network 206). The partitioning behavior is a phenomenon of the structure of layers and occurs without any specific inputs, other than camera extrinsic information (e.g., position and orientation information) and camera intrinsic information (e.g., field-of-view information, distortion information). During this phenomenon, the structure layers of the structure network 204 store information about piece-wise smooth scene parts and their motion (e.g., structural information), and and the color layers of the color network 206 store color/texture information (object color, shadows, etc.), respectively. For example, the structure layers of a natural landscape can store information that the scene is assembled from fragments of leaves and grass blades placed at different locations, while color layers store information that those fragments are green and yellow. The partitioning behavior was also discovered to include layers of MLP progressively trained on video sequences having stored structural information in layers that precede color information layers. Moreover, NeRF MLP training exhibits a relatively small number of early layers change relatively quickly over time, thus after initial training efforts have occurred the remaining layers can be kept frozen. Stated differently, the relatively faster changes in a scene (e.g., motion) occur in early layers, such as a video landscape of a grassy field where individual blades of grass change (e.g., motion) position relatively faster and/or more often than they change their color.

The example attribute network 202 takes advantage of this MLP layering behavior to improve computational efficiency by separating computational training efforts based on particular layer types. For instance, some examples disclosed herein focus on training of early (structure-based) layers while spending fewer computational resources on later (color-based) layers. Decisions of when to train particular layer types are based on training schedules that guide a particular amount of computational resources for particular layer types. Such focused training of structure-based layers or motion-based layers versus color-based layers reduces a number of MLP weights that change between video frames, which also allows weight streaming efforts to occur with fewer network bandwidth demands. For each incoming new frame of the attribute network 202, information from prior frames is used to avoid unnecessary re-calculations during training (reduces redundant learning). After initial training (e.g., a warmup phase/period) in which a primary training focus was for the color network 206 of the overall attribute network 202 while the structure network 204 was frozen, operational training status of the networks flips and/or otherwise alternates. Stated differently, during a subsequent phase the color network 206 is frozen in favor of computational resources being directed to the structure network 204, in which only the changes in layers of the structure network 204 are streamed. Example schedules of network-type training overvome problems associated with known attribute network 202 implementations that exhibit flickering artifacts across frames during subsequent rendering operations. To reduce such flickering artifacts, known attribute network 202 implementations rely on a set of precomputed static/dynamic separation masks via separate and/or otherwise alternate network pipelines to employ optical flow map estimation techniques, which are computationally and bandwidth intensive. Known attribute network 202 implementations encode layers without regard to whether they are structure-based layers or color-based layers. Additionally, known attribute network 202 implementations encode both structure-based layers and motion-based layers in a mixed manner, thus weights corresponding to each are also mixed.

Examples disclosed herein reduce flickering artifacts in a more efficient manner than prior techniques by generating and/or otherwise implementing a deformation network 208 as a front end to the attribute network 202. Additionally and/or alternatively, examples disclosed herein generate and/or otherwise establish a training schedule to enable and/or disable different portions of the separation mask network 200 to prevent interference between attribute network 202 training (e.g., training with regard to structure and color parameters of a frame of interest) and motion-related training via the example deformation network 208 (sometimes referred to herein as a motion network or a motion sub-network). Additionally, the example static/dynamic separation masks generated with the aid of the example motion deformation 208 aids in the reduction of computational costs at each frame by restricting and/or otherwise limiting ray tracing to only the dynamic regions of one frame to another. As such, network bandwidth between computational structure and rendering devices is reduced due to the corresponding reduction in the number of parameters that need to be updated.

Some examples disclosed herein separate the motion information from other attributes of a scene to permit encoding of motion information by the example deformation network 208 (e.g., by the deformation network 208 and not the structure network 204 and the color network 206). As a result, the example attribute network 202 is allowed to focus on learning other attributes of the scene that could not be accounted for by simply applying the deformation information learned from a prior frame. Stated differently, examples disclosed herein apply particular focused network models for motion information as distinguished from other attribute information, thereby preventing interference between the models that would otherwise adversely affect computational efficiency and generate visual artifacts. Because the deformation network 208 explicitly encodes motion information in a manner that is disentangled from structural data, the deformation network 208 can be used to extract motion vectors and generate separation masks. A training schedule is applied to permit the deformation network 208 to learn motion-based information from scene fragments previously learned from previous training of the attribute network 202. For example, at the beginning of any video sequence the attribute network 202 is first trained to encode scene elements before the deformation network 208 is allowed to determine whether that scene also includes particular motion-based elements. Some examples disclosed herein freeze and/or otherwise disable the example deformation network 208 during training iterations of the example attribute network 202, particularly when analyzing a first frame in a series of streamed frames. As used herein, “freezing” a network represents preventing that network from processing any data and “unfreezing” a network represents allowing that network to process data. When a network is frozen, there are no computational resources consumed by that frozen network.

For instance, a first frame in a series of frames has no prior history of analysis of learned information to reveal pixel movement, thus motion-based analysis would be of no value. Accordingly, some examples disclosed herein begin scene analysis with the example attribute network 202, which can reveal color-based attributes of a scene even if no motion has yet occurred. However, after the attribute model (e.g., the attribute network 202) learns the scene (e.g., has analyzed a frame in the scene), examples disclosed herein unfreeze (e.g., activate, unpause, enable) the example deformation network 208 and freeze (e.g., deactivate, pause, disable) the example attribute network 202 to learn motion-based information corresponding to the first and second frames. Subsequent frames thereafter (e.g., a third, fourth, fifth, etc.) are trained based on a particular network activation schedule in which some frames use only the deformation network 208 while the attribute network 202 is inactive, and vice versa for an adjacent frame, and so on. To generate reliable motion estimation information via the example deformation network 208 (e.g., the motion network), examples disclosed herein apply motion estimation information from prior frames as starting points to define a deformation loss, thereby avoiding jittering artifacts.

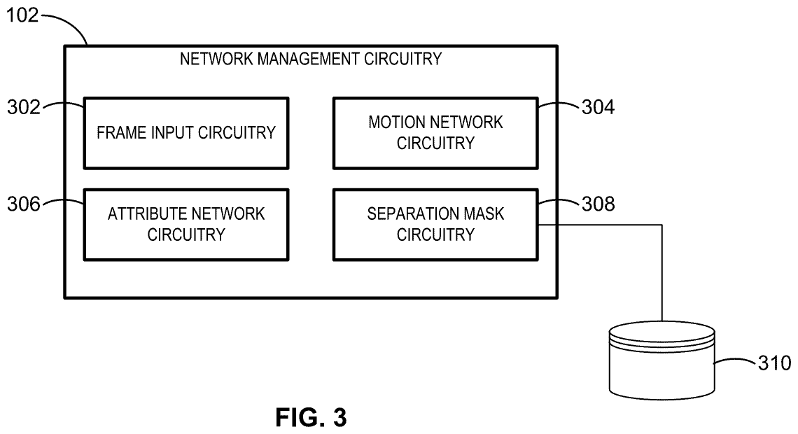

FIG. 3 is a block diagram of an example implementation of the example network management circuitry 102 of FIG. 1. In the illustrated example of FIG. 3, the network management circuitry 102 includes example frame input circuitry 302, example motion network circuitry 304, example attribute network circuitry 306, and example separation mask circuitry 308 communicatively connected to an example mask database 310. In operation, the example frame input circuitry 302 determines whether an input frame has been received for processing. If so, the example frame input circuitry 302 determines whether the received frame is a first input frame. As described above, in the event a first frame corresponding to a scene or stream is received, then there will be no prior frame data available from which to determine motion of any of the pixels within the frame. As such, applying any motion-based analysis on the first frame would produce no beneficial information.

Therefore, if the example frame input circuitry 302 determines that the received frame is a first input frame, then the example motion network circuitry 304 deactivates (e.g., freezes) the example structure network 204 and the example attribute network circuitry 306 activates the example attribute network 202. When the motion sub-network 208 is frozen and the attribute network 202 is active, the example attribute network circuitry 306 trains the attribute network 202.

In the event the example frame input circuitry 302 determines that the received input frame is not the first input frame (e.g., it determines the received input frame is the second input frame), then the adjacent frame is temporally after the first input frame and the possibility exists that portions of the second input frame exhibit motion relative to that first frame. As such, the example motion network circuitry 304 activates the motion network 208 and the attribute network circuitry 306 deactivates the attribute network 202. The example motion network 304 then trains the motion network 208.

With at least two frames analyzed in this manner, examples disclosed herein facilitate generation of a separation mask based on pixels that may have exhibited motion. As used herein, a “separation mask” is a binary mask or data structure to identify and/or otherwise separate static pixels (e.g., pixels that do not exhibit motion) from dynamic pixels (e.g., pixels that exhibit motion). In some examples, the separation mask represents dynamic pixels or rays in an image/scene with a value of one (“1”) and static pixels or rays in the image/scene with a value of zero (“0”). Generated separation masks are, in some examples, stored in a data structure, such as an example mask data storage 310 of FIG. 3. The example network management circuitry 102 of some examples restricts and/or otherwise limits ray tracing to only those pixels that exhibit motion (e.g., by referencing a generated separation mask data structure), thereby reducing bandwidth requirements and improving an efficiency of the frame analysis. During subsequent iterations of additional frames corresponding to the scene or a stream input, such as a third, fourth and fifth input frame, the example network management circuitry 102 configures and/or otherwise applies a network activation schedule. For example, the network activation schedule may flip-flop every other frame in which the deformation network 208 is active while the attribute network 202 is inactive for odd numbered frames, and vice versa for event numbered frames. In some examples, the network management circuitry 102 causes activation and deactivation of particular networks based on a peak signal-to-noise ratio (PSNR) between estimated red-green-blue (RGB) values and ground truth RGB values of a training phase. For instance, a particular network may be trained until a PSNR value is greater than a predetermined threshold PSNR value (e.g., set by a user). In some examples, the threshold PSNR value corresponds to quality criteria of a training iteration, which may be measured in decibels (e.g., a PSNR of 29 dB was measured for the first frame, and a PSNR of 30 dB was measured for subsequent frames without further improvement as iterations continue). In some examples, the network management circuitry 102 causes activation and deactivation of particular networks based on parameter weight values after training iterations and/or particular weight value deltas as training iterations proceed.

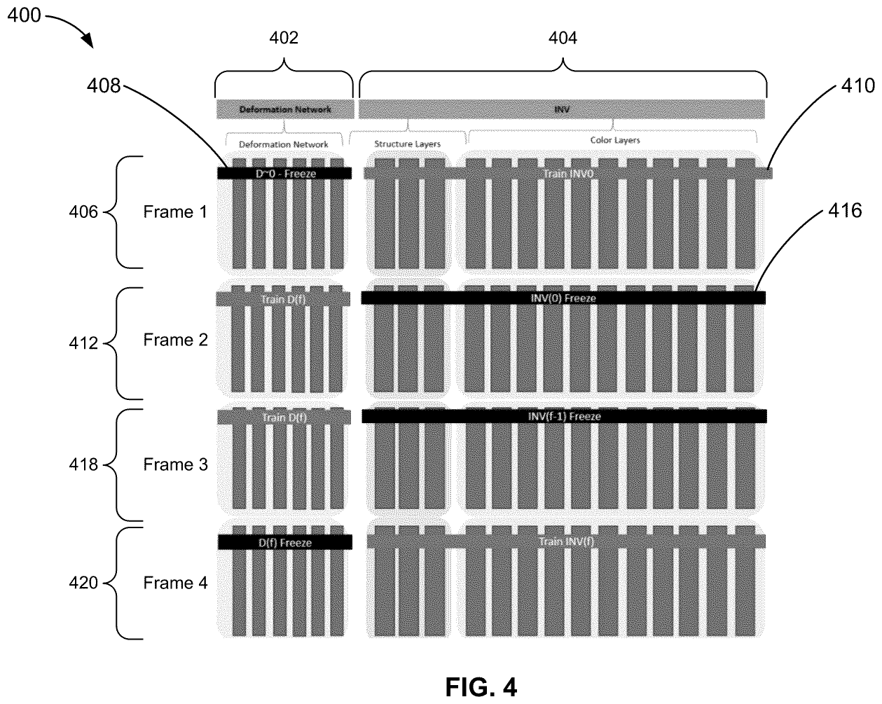

FIG. 4 is an example network activation schedule 400 for separation mask estimation. In the illustrated example of FIG. 4, the network activation schedule 400 includes a deformation network column 402, which refers to an operating status of the example deformation network 208 (also referred to herein as the motion network 208), and an incremental neural video (INV) network column 404 (also referred to as an attribute column), which refers to an operating status of the example attribute network 202 (also referred to herein as the INV network 202). The operating status of any particular network in the example network activation schedule 400 is either inactive (frozen) or active (unfrozen). When a particular network is inactive, then it does not cause any interference to either (a) the other network that might be active or (b) the computational resources that are analyzing the active network. Stated differently, known networks generate model parameters when trained. If a network includes two or more network portions, or if two or more networks are trained together, then the resulting model parameters are all influenced by any and all networks being trained. As such, if the deformation network 208 and the attribute network 202 are trained together, then any parameters corresponding to deformation (e.g., movement) are derived based on some degree of influence from the attribute network 202, and any parameters corresponding to attributes (e.g., color) are derived based on some degree of influence from the deformation network 208. In other words, the derived parameters are the result of interference from one or more other networks (e.g., networks that may not be designed to process the desired characteristics of a scene). Accordingly, some examples disclosed herein generate a clear separation of motion characteristics from other attributes of the scene by facilitating explicit neural network focus per unit of time.

When network analysis begins at a first frame 406, which is represented by a first row 406 of the illustrated example schedule 400 of FIG. 4, the deformation network 208 is frozen (see freeze indicator 408) and the attribute network 202 is unfrozen and/or otherwise active for training (see train indicator 410). As described above, during initial stages of scene analysis there is no reason for the deformation network 208 to seek and/or otherwise attempt to analyze movement information because there are no pixel positions that occur prior to the analysis. In some examples disclosed herein, a particular frame (e.g., the first frame 406) is trained for a fixed number of iterations. The number of iterations is predetermined in some examples, which may be based on empirical assessments and particular scene types. For example, in some examples a first type of scene is trained with 100,000 iterations to achieve a threshold degree of quality, while a second type of scene is trained with 10,000 iterations to achieve that same threshold degree of quality.

After the first frame 406 is analyzed, the example network activation schedule 400 causes analysis of a second frame 412, which is represented by a second row 412 of the illustrated example schedule 400 of FIG. 4. During analysis of the second frame 408, because there exists a possibility that some pixels exhibit motion information the example deformation network is unfrozen (see train indicator 414) and the example attribute network 202 is frozen (see free indicator 416).

In the illustrated example of FIG. 4, the schedule 400 includes a third row 418 and a fourth row 420 to identify which particular networks are to remain active or inactive. While the illustrated example of FIG. 4 includes an active deformation network 208 and inactive attribute network 202 in the third row 418, examples disclosed herein are not limited thereto. Active and inactive arrangements may follow any type of schedule including, but not limited to schedules in which the participating networks alternate their active and inactive status on a frame-by-frame basis. In some examples, the active and inactive status is based on training metrics of one or more networks, such as particular learned parameter thresholds, thresholds based on parameter delta values and/or signal-to-noise ratios of the frames being analyzed.

As described above, FIG. 3 is a block diagram of an example implementation of the network management circuitry of FIG. 1 to do separation mask estimation. The network management circuitry of FIG. 3 may be instantiated (e.g., creating an instance of, bring into being for any length of time, materialize, implement, etc.) by programmable circuitry such as a Central Processor Unit (CPU) executing first instructions. Additionally or alternatively, the network management circuitry of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

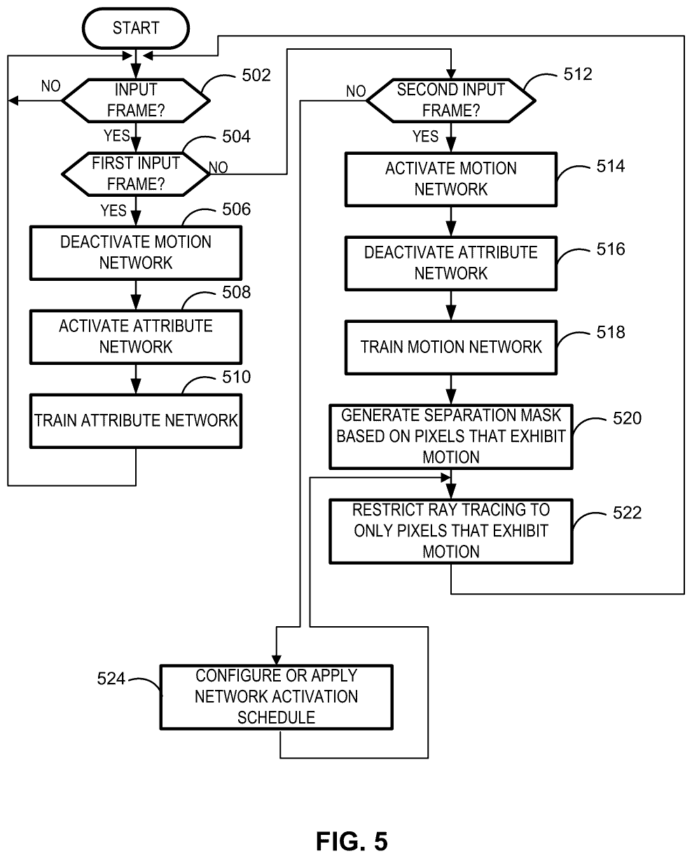

In some examples, the frame input circuitry 302, the motion network circuitry 304, the attribute network circuitry 306, the separation mask circuitry 308 and the network management circuitry 102 is instantiated by programmable circuitry executing, respectively, frame input instructions, motion network instructions, attribute network instructions, separation mask instructions, and network management instructions and/or configured to perform operations such as those represented by the flowchart of FIG. 5.

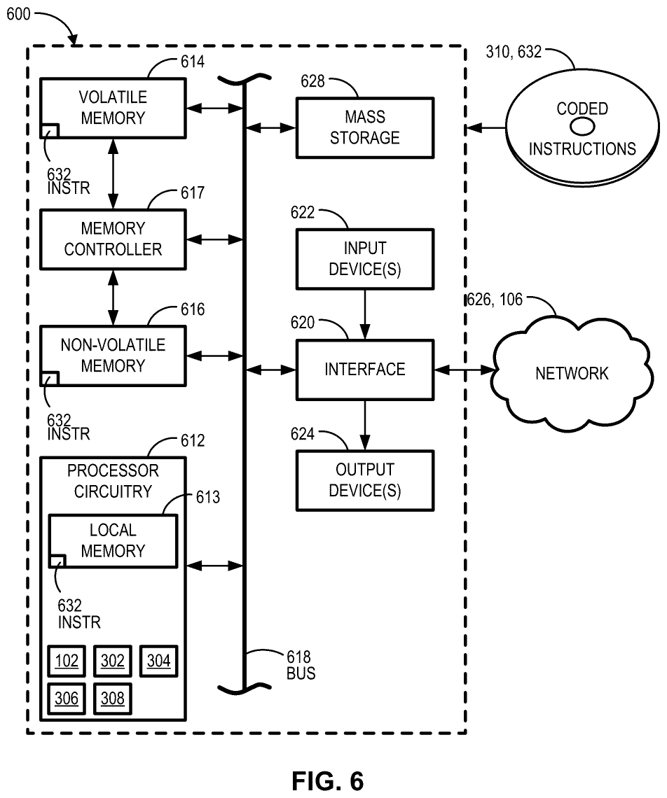

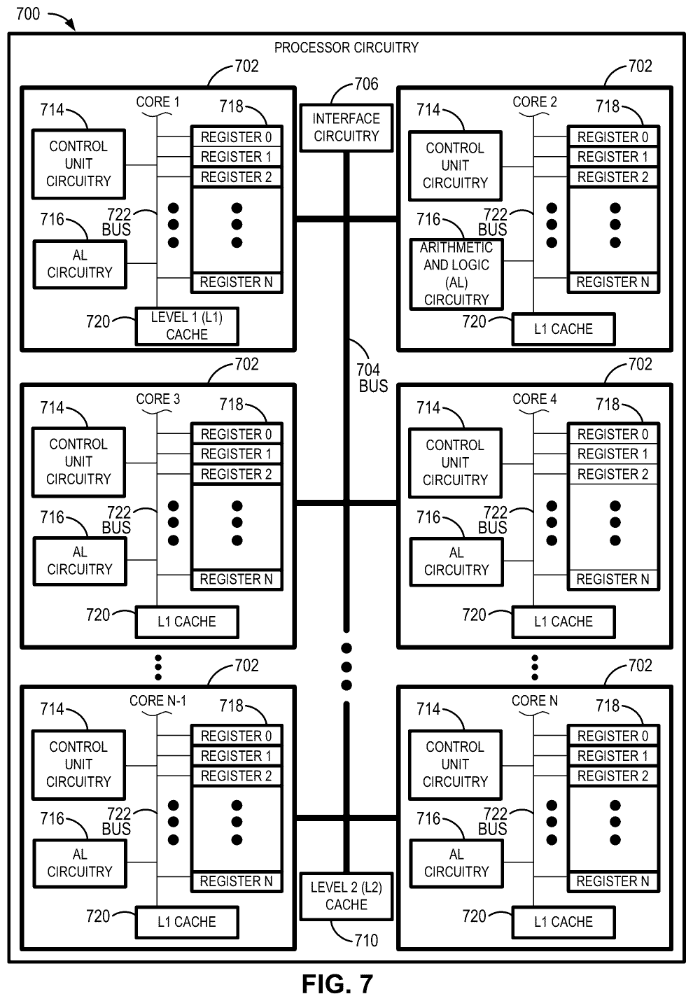

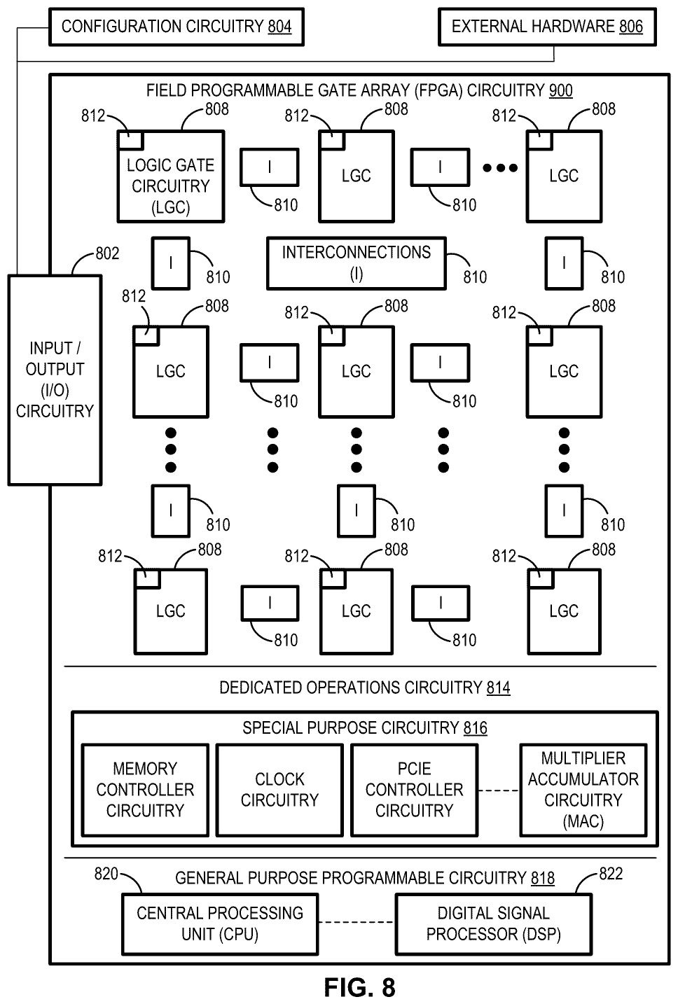

In some examples, the network management circuitry includes means for frame input detection, means for motion network control, means for attribute network control, means for mask separation, and means for network management. For example, the means for frame input detection may be implemented by frame input circuitry 302, the means for motion network control may be implemented by motion network circuitry 304, the means for attribute network control may be implemented by attribute network circuitry 306, the means for mask separation may be implemented by separation mask circuitry 308, and the means for network management may be implemented by network management circuitry 102. In some examples, the aforementioned circuitry may be instantiated by programmable circuitry such as the example programmable circuitry 612 of FIG. 6. For instance, the aforementioned circuitry may be instantiated by the example microprocessor 700 of FIG. 7 executing machine executable instructions such as those implemented by at least the blocks of FIG. 5. In some examples, the aforementioned circuitry may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the network management circuitry of FIG. 1 is illustrated in FIG. 3, one or more of the elements, processes, and/or devices illustrated in FIG. 3 may be combined, divided, re-arranged, omitted, eliminated, and/or implemented in any other way. Further, the example frame input circuitry 302, the example motion network circuitry 304, the example attribute network circuitry 306, the example separation mask circuitry 308, and/or, more generally, the example network management circuitry of FIG. 3, may be implemented by hardware alone or by hardware in combination with software and/or firmware. Thus, for example, any of the example frame input circuitry 302, the example motion network circuitry 304, the example attribute network circuitry 306, the example separation mask circuitry 308, and/or, more generally, the example network management circuitry of FIG. 3, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example network management circuitry of FIG. 3 may include one or more elements, processes, and/or devices in addition to, or instead of, those illustrated in FIG. 3, and/or may include more than one of any or all of the illustrated elements, processes and devices.

Flowchart(s) representative of example machine readable instructions, which may be executed by programmable circuitry to implement and/or instantiate the network management circuitry of FIG. 3 and/or representative of example operations which may be performed by programmable circuitry to implement and/or instantiate the network management circuitry of FIG. 3, are shown in FIG. 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 5, many other methods of implementing the example network management circuitry may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 5 is a flowchart representative of example machine readable instructions and/or example operations 500 that may be executed, instantiated, and/or performed by programmable circuitry to improve separation mask estimation. The example machine-readable instructions and/or the example operations 500 of FIG. 5 begin at block 502, at which the example frame input circuitry 302 determines whether an input frame has been received in connection with scene analysis. As described above, while traditional approaches of scene analysis require one or more buffers or other memory elements filled with several seconds or minutes of video content, examples disclosed herein accept frame input on a frame-by-frame basis during a scene analysis task, thereby eliminating a need for buffer resources. Instead, parameters learned from a first frame are used as a starting point basis when analyzing and/or otherwise training subsequent frames, thereby avoiding recalculation and/or duplicative computational effort.

If the example frame input circuitry 302 determines that the received input frame is a first input frame associated with a scene analysis request (block 504), then the example motion network circuitry 304 deactivates the motion network 208 (block 506), and the example attribute network circuitry 306 activates the attribute network 202 (block 508). This particular arrangement of network activation/deactivation allows a focus of frame analysis on image attributes that are unassociated with motion information. The example attribute network circuitry 306 trains the attribute network 202 in view of the received frame (block 510).

If the example frame input circuitry 302 determines that the received input frame is not a first input frame (e.g., a second or more input frame) (block 504), then the frame input circuitry 302 determines whether the received frame is a second input frame (block 512). Stated differently, knowledge that a received frame is the second input frame represents a first instance where motion information from the first frame to the second frame might occur. Stated differently, the scene analysis task now has a pipeline of frames that may reveal both attribute information and motion information, and the second frame is the first opportunity to assess motion-related aspects of the scene.

The example motion network circuitry 304 activates the motion network 208 (e.g., the deformation network 208) (block 514) and the example attribute network circuitry 306 deactivates the attribute network 202 so that analysis of the second frame is focused on motion-based phenomena only (block 516). The example motion network circuitry 304 trains the motion network 208 (block 518) and the separation mask circuitry 308 generates a separation mask based on pixels that exhibit motion (block 520). Because knowledge of motion-based pixels is now available, the example network management circuitry 102 is able to improve an efficiency when rendering, for example, free-viewpoint images. The network management circuitry 102 restricts ray tracing to only those pixels that exhibit motion (e.g., spatial movement) characteristics (block 522).

In the event the example frame input circuitry 302 determines that a received frame is not the second input frame (block 512), then the received input frame must be a third input frame or greater. As such, the network management circuitry 102 implements a particular network activation/deactivation schedule (block 524). Examples disclosed herein enable any type of activation/deactivation schedule including, but not limited to, a schedule that alternates the activation and deactivation upon receipt of every other frame, maintaining an activation or deactivation of particular networks for a particular number of received frames, or controlling a network activation/deactivation status based on metrics associated with the scene or one or more frames (e.g., learned parameter values, parameter value change thresholds, signal-to-noise ratio values, etc.).

FIG. 6 is a block diagram of an example programmable circuitry platform 600 structured to execute and/or instantiate the example machine-readable instructions and/or the example operations of FIG. 5 to implement the network management circuitry of FIG. 3. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the example frame input circuitry 302, the example motion network circuitry 304, the example attribute network circuitry 306, the example separation mask circuitry, and the example network management circuitry 102.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIG. 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowchart of FIG. 5 to effectively instantiate the circuitry of FIG. 2 as logic circuits to perform operations corresponding to those machine readable instructions. In some such examples, the circuitry of FIG. 3 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowchart of FIG. 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMS s), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIG. 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart of FIG. 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart of FIG. 5. As such, the FPGA circuitry 800 may be configured and/or structured to effectively instantiate some or all of the operations/functions corresponding to the machine readable instructions of the flowchart of FIG. 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIG. 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart of FIG. 5 to perform first operation(s)/function(s), the FPGA circuitry 800 of FIG. 8 may be configured and/or structured to perform second operation(s)/function(s) corresponding to a second portion of the machine readable instructions represented by the flowchart of FIG. 5, and/or an ASIC may be configured and/or structured to perform third operation(s)/function(s) corresponding to a third portion of the machine readable instructions represented by the flowchart of FIG. 5.

It should be understood that some or all of the circuitry of FIG. 3 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 3 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

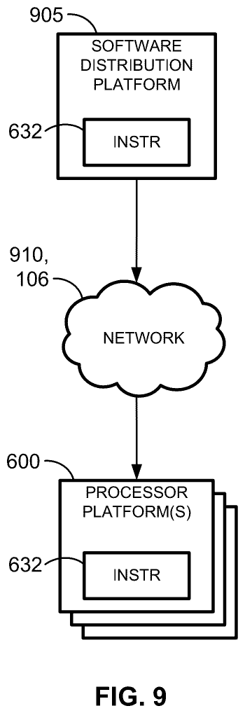

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIG. 5, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 5, may be downloaded to the example programmable circuitry platform 600, which is to execute the machine readable instructions 632 to implement the network management circuitry. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time within 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that improve separation mask estimation. In particular, some examples disclosed herein enable separation mask estimation to occur on a frame-by-frame basis in which large quantities of input frames are not required to be stored for bulk training. Instead, examples disclosed herein train data corresponding to a frame (e.g., pixels) using a particular neural network and retain trained values to serve as a basis when training any subsequently received frame, thereby avoiding duplicative computational efforts. In some disclosed frame-by-frame examples, scene analysis is performed in a streaming environment where a bulk quantity of frames is unavailable. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture for static and dynamic separation mask estimation are disclosed herein. Further examples and combinations thereof include the following:

Example 1 includes an apparatus comprising interface circuitry, instructions, and programmable circuitry to at least one of instantiate or execute the instructions to deactivate a motion network and activate an attribute network in response to a frame input of a stream to a neural network, train the attribute network based on the frame input, activate the motion network and deactivate the attribute network in response to a subsequent frame input of the stream to the neural network, train the motion network based on the subsequent frame, and determine pixels of the stream that are moving.

Example 2 includes the apparatus as defined in example 1, wherein the programmable circuitry is to reduce a quantity of pixel parameters to be updated by limiting ray tracing of the stream to the pixels that exhibit spatial movement.

Example 3 includes the apparatus as defined in example 1, wherein the programmable circuitry is to alternate activation and deactivation of the motion and attribute networks on a frame-by-frame basis.

Example 4 includes the apparatus as defined in example 1, wherein the programmable circuitry is to alternate activation and deactivation of the motion and attribute networks based on network weight change threshold values.

Example 5 includes the apparatus as defined in example 1, wherein the programmable circuitry is to alternate activation and deactivation of the motion and attribute networks based on threshold peak signal-to-noise ratio values.

Example 6 includes the apparatus as defined in example 1, wherein the programmable circuitry is to separate motion-based pixel training and attribute-based pixel training.

Example 7 includes the apparatus as defined in example 1, wherein the motion network is a deformation network.

Example 8 includes the apparatus as defined in example 1, wherein the attribute network is a neural radiance field (NeRF) network.

Example 9 includes the apparatus as defined in example 1, wherein the programmable circuitry is to reduce jitter artifacts of the stream.

Example 10 includes the apparatus as defined in example 9, wherein the programmable circuitry is to apply learned network parameters corresponding to the frame as inputs to the subsequent frame to reduce the jitter artifacts.

Example 11 includes the apparatus as defined in example 1, wherein the programmable circuitry is to generate the neural network by adding the motion network to a front-end of the attribute network.

Example 12 includes the apparatus as defined in example 1, wherein the frame input is a first frame input of the stream and the subsequent frame input is a second frame input of the stream.

Example 13 includes the apparatus as defined in example 1, wherein the stream is a video stream.

Example 14 includes a non-transitory computer readable storage medium comprising instructions to cause programmable circuitry to at least disable a motion network and enable an attribute network after receiving a frame input of a data stream to a neural network, train the attribute network based on the frame input, enable the motion network and disable the attribute network in response to a subsequent frame input of the data stream to the neural network, train the motion network based on the subsequent frame, and determine data points of the data stream that are moving.

Example 15 includes the non-transitory computer readable storage medium as defined in example 14, wherein the instructions cause the programmable circuitry to limit ray tracing of the data stream to data points that exhibit spatial movement characteristics.

Example 16 includes the non-transitory computer readable storage medium as defined in example 15, wherein the instructions cause the programmable circuitry to reduce a quantity of pixel parameters to be updated by limiting the ray tracing of the data stream.

Example 17 includes the non-transitory computer readable storage medium as defined in example 14, wherein the instructions cause the programmable circuitry to alternate enabling and disabling of the motion network and the attribute network on a frame-by-frame basis.

Example 18 includes the non-transitory computer readable storage medium as defined in example 14, wherein the instructions cause the programmable circuitry to alternate enabling and disabling of the motion network and the attribute network based on network weight change threshold values.

Example 19 includes the non-transitory computer readable storage medium as defined in example 14, wherein the instructions cause the programmable circuitry to alternate enabling and disabling of the motion network and the attribute network based on threshold peak signal-to-noise ratio values.

Example 20 includes the non-transitory computer readable storage medium as defined in example 14, wherein the instructions cause the programmable circuitry to separate motion-based pixel training and attribute-based pixel training.

Example 21 includes the non-transitory computer readable storage medium as defined in example 14, wherein the motion network is a deformation network.

Example 22 includes the non-transitory computer readable storage medium as defined in example 14, wherein the attribute network is a neural radiance field (NeRF) network.

Example 23 includes the non-transitory computer readable storage medium as defined in example 14, wherein the instructions cause the programmable circuitry to reduce jitter artifacts of the data stream.

Example 24 includes the non-transitory computer readable storage medium as defined in example 23, wherein the instructions cause the programmable circuitry to apply learned network parameters corresponding to the frame as inputs to the subsequent frame to reduce the jitter artifacts.

Example 25 includes an apparatus comprising means for motion network control to deactivate a motion network in response to a frame input of a stream to a neural network, means for attribute network control to activate an attribute network, and train the attribute network based on the frame input, the means for motion network control to activate the motion network, the means for attribute network control to deactivate the attribute network in response to a subsequent frame input of the stream to the neural network, and train the motion network based on the subsequent frame input, and means for mask separation to determine pixels of the stream that exhibit motion characteristics.

Example 26 includes the apparatus as defined in example 25, further including means for network management to restrict ray tracing of the stream to the pixels that exhibit the motion characteristics.

Example 27 includes the apparatus as defined in example 25, wherein the means for motion network control and the means for attribute network control are to alternate activation and deactivation of the motion network and the attribute network on a frame-by-frame basis, respectively.

Example 28 includes the apparatus as defined in example 25, wherein the means for motion network control and the means for attribute network control are to alternate activation and deactivation of the motion network and the attribute network, respectively, based on network weight change threshold values.

Example 29 includes the apparatus as defined in example 25, wherein the means for motion network control and the means for attribute network control are to alternate activation and deactivation of the motion network and the attribute network, respectively, based on peak signal-to-noise ratio values.

Example 30 includes the apparatus as defined in example 25, wherein the means for network management are to separate motion-based pixel training and attribute-based pixel training.

Example 31 includes a method comprising disabling a motion network and enabling an attribute network, by executing instructions with processor circuitry, after receiving a frame input of a data stream to a neural network, training, by executing instructions with the processor circuitry, the attribute network based on the frame input, enabling the motion network and disabling the attribute network, by executing instructions with the processor circuitry, in response to a subsequent frame input of the data stream to the neural network, training, by executing instructions with the processor circuitry, the motion network based on the subsequent frame, and determining, by executing instructions with the processor circuitry, data points of the data stream that exhibit motion characteristics.

Example 32 includes the method as defined in example 31, further including limiting ray tracing of the data stream to data points that exhibit the motion characteristics.

Example 33 includes the method as defined in example 31, further including reducing a quantity of pixel parameters to be updated by limiting the ray tracing of the data stream.

Example 34 includes the method as defined in example 31, further including alternating enabling and disabling of the motion network and the attribute network on a frame-by-frame basis.

Example 35 includes the method as defined in example 31, further including alternating enabling and disabling of the motion network and the attribute network based on network weight change threshold values.

Example 36 includes the method as defined in example 31, further including alternating enabling and disabling of the motion network and the attribute network based on threshold peak signal-to-noise ratio values.

Example 37 includes the method as defined in example 31, further including separating motion-based pixel training and attribute-based pixel training.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. An apparatus comprising:
interface circuitry;
instructions; and
programmable circuitry to at least one of instantiate or execute the instructions to:
deactivate a motion network and activate an attribute network in response to a frame input of a stream to a neural network;
train the attribute network based on the frame input;
activate the motion network and deactivate the attribute network in response to a subsequent frame input of the stream to the neural network;
train the motion network based on the subsequent frame; and
determine pixels of the stream that are moving.

2. The apparatus as defined in claim 1, wherein the programmable circuitry is to reduce a quantity of pixel parameters to be updated by limiting ray tracing of the stream to the pixels that exhibit spatial movement.

3. The apparatus as defined in claim 1, wherein the programmable circuitry is to alternate activation and deactivation of the motion and attribute networks on a frame-by-frame basis.

4. The apparatus as defined in claim 1, wherein the programmable circuitry is to alternate activation and deactivation of the motion and attribute networks based on network weight change threshold values.

5. The apparatus as defined in claim 1, wherein the programmable circuitry is to alternate activation and deactivation of the motion and attribute networks based on threshold peak signal-to-noise ratio values.

6-8. (canceled)

9. The apparatus as defined in claim 1, wherein the programmable circuitry is to reduce jitter artifacts of the stream.

10. The apparatus as defined in claim 9, wherein the programmable circuitry is to apply learned network parameters corresponding to the frame as inputs to the subsequent frame to reduce the jitter artifacts.

11. The apparatus as defined in claim 1, wherein the programmable circuitry is to generate the neural network by adding the motion network to a front-end of the attribute network.

12-13. (canceled)

14. A non-transitory computer readable storage medium comprising instructions to cause programmable circuitry to at least:
disable a motion network and enable an attribute network after receiving a frame input of a data stream to a neural network;
train the attribute network based on the frame input;
enable the motion network and disable the attribute network in response to a subsequent frame input of the data stream to the neural network;
train the motion network based on the subsequent frame; and
determine data points of the data stream that are moving.

15. The non-transitory computer readable storage medium as defined in claim 14, wherein the instructions cause the programmable circuitry to limit ray tracing of the data stream to data points that exhibit spatial movement characteristics.

16. The non-transitory computer readable storage medium as defined in claim 15, wherein the instructions cause the programmable circuitry to reduce a quantity of pixel parameters to be updated by limiting the ray tracing of the data stream.

17. The non-transitory computer readable storage medium as defined in claim 14, wherein the instructions cause the programmable circuitry to alternate enabling and disabling of the motion network and the attribute network on a frame-by-frame basis.

18. The non-transitory computer readable storage medium as defined in claim 14, wherein the instructions cause the programmable circuitry to alternate enabling and disabling of the motion network and the attribute network based on network weight change threshold values.

19. The non-transitory computer readable storage medium as defined in claim 14, wherein the instructions cause the programmable circuitry to alternate enabling and disabling of the motion network and the attribute network based on threshold peak signal-to-noise ratio values.

20-21. (canceled)

22. The non-transitory computer readable storage medium as defined in claim 14, wherein the attribute network is a neural radiance field (NeRF) network.

23. The non-transitory computer readable storage medium as defined in claim 14, wherein the instructions cause the programmable circuitry to reduce jitter artifacts of the data stream.

24. The non-transitory computer readable storage medium as defined in claim 23, wherein the instructions cause the programmable circuitry to apply learned network parameters corresponding to the frame as inputs to the subsequent frame to reduce the jitter artifacts.

25-30. (canceled)

31. A method comprising:
disabling a motion network and enabling an attribute network, by executing instructions with processor circuitry, after receiving a frame input of a data stream to a neural network;
training, by executing instructions with the processor circuitry, the attribute network based on the frame input;
enabling the motion network and disabling the attribute network, by executing instructions with the processor circuitry, in response to a subsequent frame input of the data stream to the neural network;
training, by executing instructions with the processor circuitry, the motion network based on the subsequent frame; and
determining, by executing instructions with the processor circuitry, data points of the data stream that exhibit motion characteristics.

32. The method as defined in claim 31, further including limiting ray tracing of the data stream to data points that exhibit the motion characteristics.

33. The method as defined in claim 31, further including reducing a quantity of pixel parameters to be updated by limiting the ray tracing of the data stream.

34-37. (canceled)
